(19) United States
(12) Patent Application Publication
(10) Pub. No.: US 2015/0379010 A1
(43) Pub. Date: Dec. 31, 2015

(54) Dynamic Concept Based Query Expansion

(71) Applicant: International Business Machines Corporation, Armonk, NY (US)

(72) Inventors: Corville O. Allen, Morrisville, NC (US); Sai Prathyusha Peddi, Dublin, OH (US); Shannon E. Watanabe, Columbus, OH (US)

(21) Appl. No.: 14/315,118

(22) Filed: Jun. 25, 2014

(51) Int. Cl. G06F 17/30

(52) U.S. Cl. CPC G06F 17/3043; G06F 17/30976; G06F 17/3053

(57) ABSTRACT

An approach is provided expand queries processed by a question/answer (QA) system. In the approach, concepts are extracted from documents using natural language processing to identify the concepts included in passages found in the documents. The approach generates child level categories in a category hierarchy from the concepts and groups the child level categories into sets based on related concepts. The process creates parent categories from the sets and divides a corpus used by the QA system into a number of sub-corpora, with each of the sub-corpora corresponding to one of the child level categories. The approach answers questions posed to the QA system by identifying a child level category related to the question and searching the sub-corpora corresponding to the child level category.

### BACKGROUND OF THE INVENTION

A question answering system (QA system) is effective in processing unstructured data. For example, in a healthcare environment, a QA system effectively processes the unstructured data found in medical resources, working with the most current knowledge available and reduces the burden associated with reading and synthesizing vast amounts of data stored in patient records. This involves automatic extracting and structuring knowledge from the natural language resources. A standard search in a QA system is often based on an indexing method that uses a “bag of words” approach. The superfluous data retrieved through the search does not yield good results. Traditional QA systems do not effectively utilize key concepts maintained in the unstructured data to remove superfluous and irrelevant results. The main challenge in a traditional QA system is that the bag of words and weighting-based search in the primary search where the match is typically across documents with high match. In such a traditional approach, the hits may include extra documents that are only relevant in a broad sense and pollute and break further algorithms.

### SUMMARY

An approach is provided expand queries processed by a question/answer (QA) system. In the approach, concepts are extracted from documents using natural language processing to identify the concepts included in passages found in the documents. The approach generates child level categories in a category hierarchy from the concepts and groups the child level categories into sets based on related concepts. The process creates parent categories from the sets and divides a corpus used by the QA system into a number of sub-corpora, with each of the sub-corpora corresponding to one of the child level categories. The approach answers questions posed to the QA system by identifying a child level category related to the question and searching the sub-corpora corresponding to the child level category

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a Question/Answer (QA) system that utilizes a knowledge base;

FIG. 2 is a block diagram of a processor and components of an information handling system such as those shown in FIG. 1;

FIG. 3 is a higher level flowchart depicting the higher level pre-processing steps and runtime steps used in dynamic concept based query expansion;

FIG. 4 is a depiction of a flowchart showing the logic used during pre-processing to provide dynamic concept based query expansion;

FIG. 5 is a depiction of a flowchart showing the logic used during runtime processing to provide dynamic concept based query expansion;

FIG. 6 is an example document being ingested by the system; and

FIG. 7 is a depiction of the concepts found in the example document shown in FIG. 6 as well as the dynamic categories created from the ingestion of the example document.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

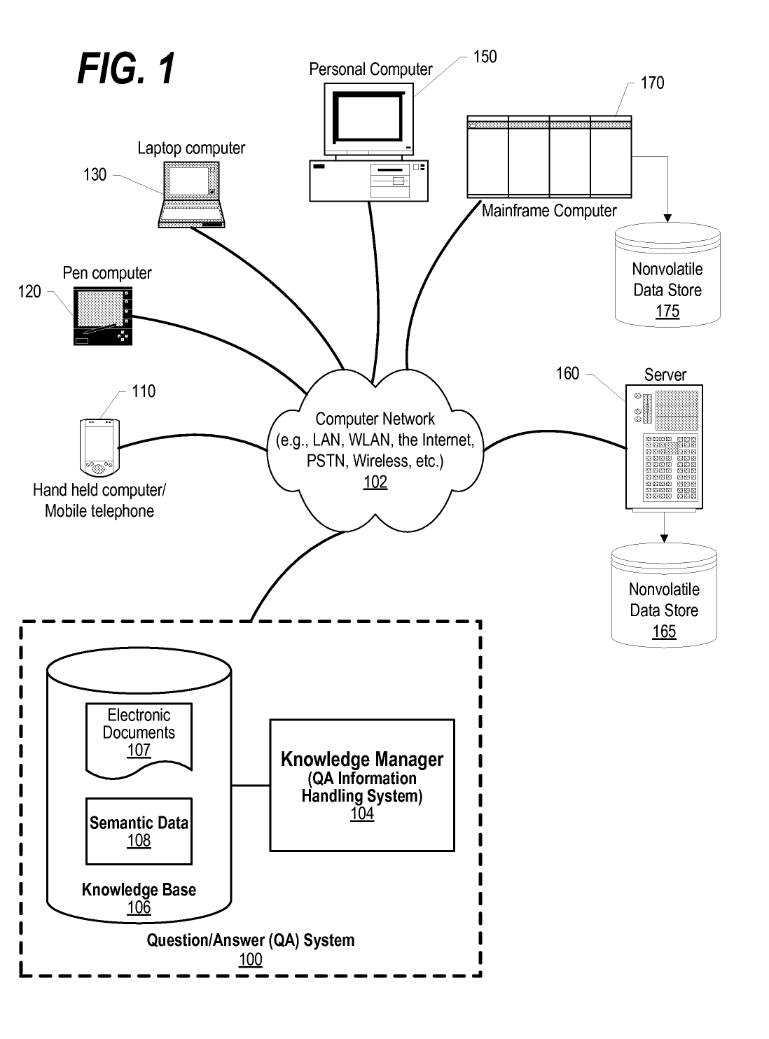

FIG. 1 depicts a schematic diagram of one illustrative embodiment of a question/answer creation (QA) system 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 106 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 100. The document 106 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

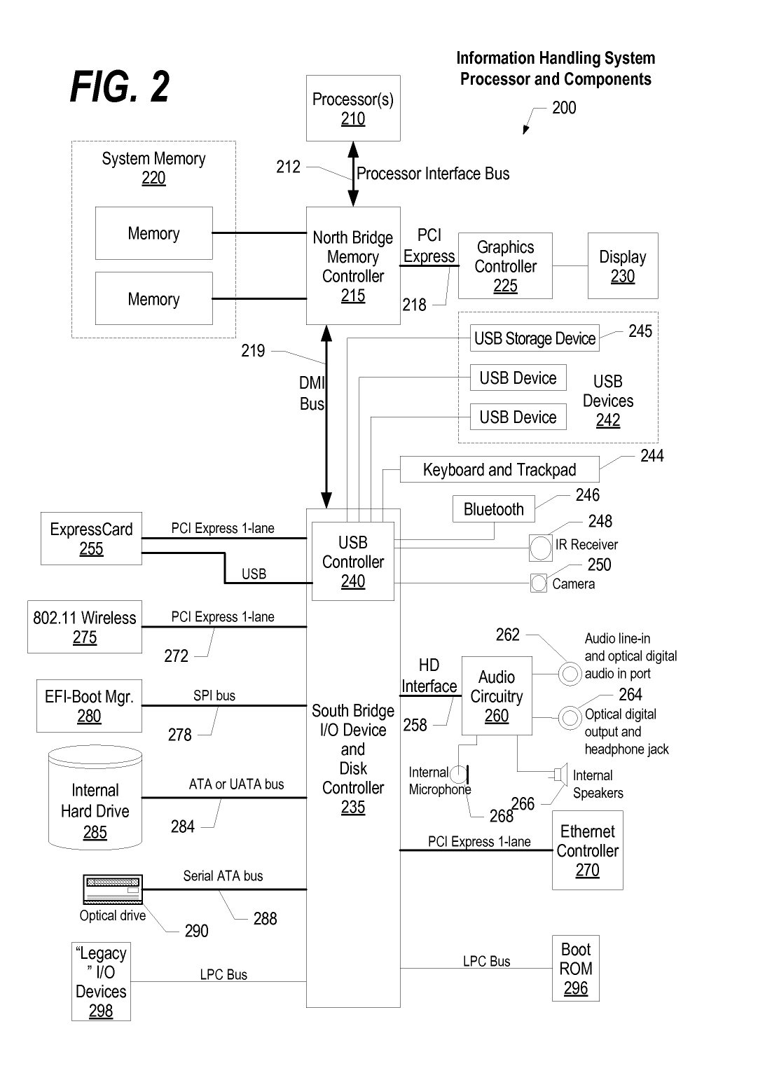

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE. 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

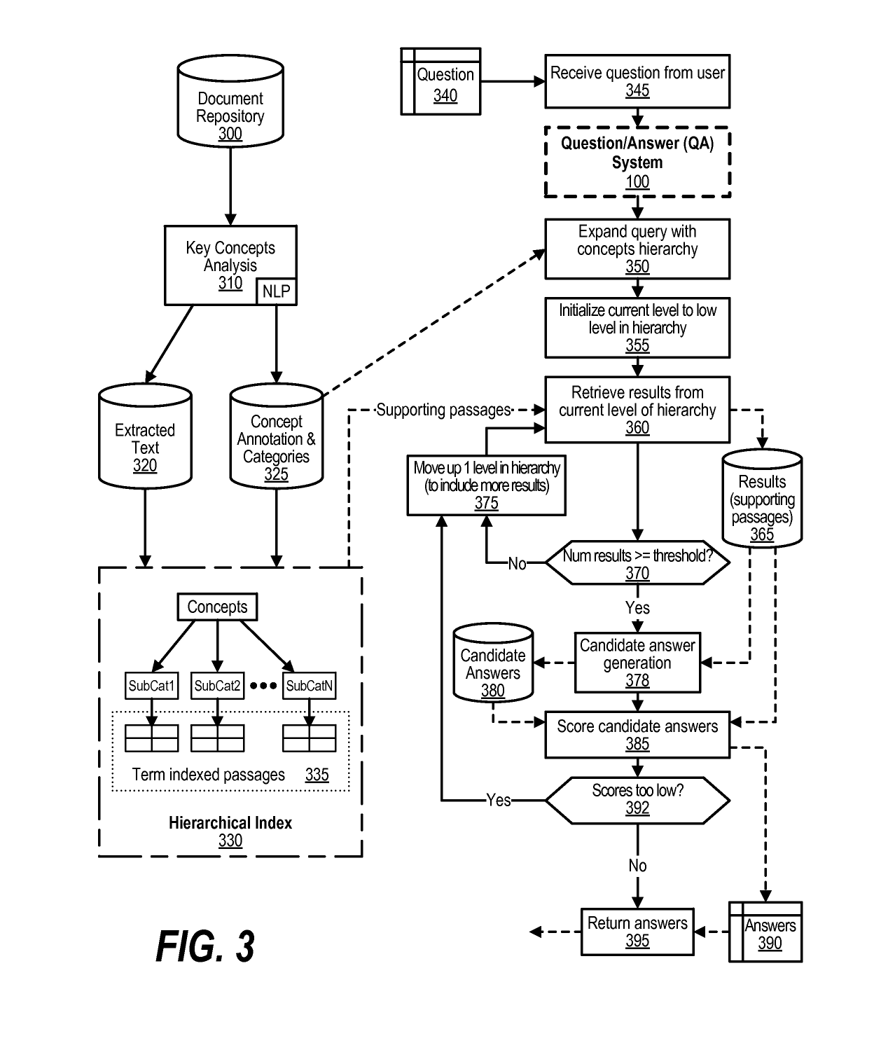

FIGS. 3-7 depict an approach that can be executed on an information handling system, to provide dynamic concept based query expansion. The approach described herein identifies key concepts from a question analysis and, based on the key concepts, targets an index that is concept focused to produce more accurate results. This approach is useful in certain environments, such as a healthcare environment where patient records are being analyze. Another feature of the approach is dynamically expanding concept query to include similar index repositories based on the search result hits and threshold. This expansion serves to increase the results needed for a valid result. In this approach, the results (answers) are more focused on the key concepts based on the context and question analysis. By targeting the correct section of corpus (sub-corpora) for evidence, the scoring and processing of the candidate answers produces more accurate results. In another embodiment, the approach performs dynamic expansion of the search if the concept is too narrow from the resultant hits. This expansion dynamically adjusts based on the concept hierarchy and might be based on the terms of the concept or the ontology of the concept. Key concepts can be mined from learning models on the most influential terms for a domain or an area.

FIG. 3 is a higher level flowchart depicting the higher level pre-processing steps and runtime steps used in dynamic concept based query expansion. Document repository 300 includes a number of documents that pre-processing ingests into the corpus and sub-corpora. During pre-processing, key concepts analysis 310 is performed by utilizing natural language processing (NLP) to identify the concepts included in the natural language passages found in the documents of document repository 300. As used herein, “NLP” refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input.

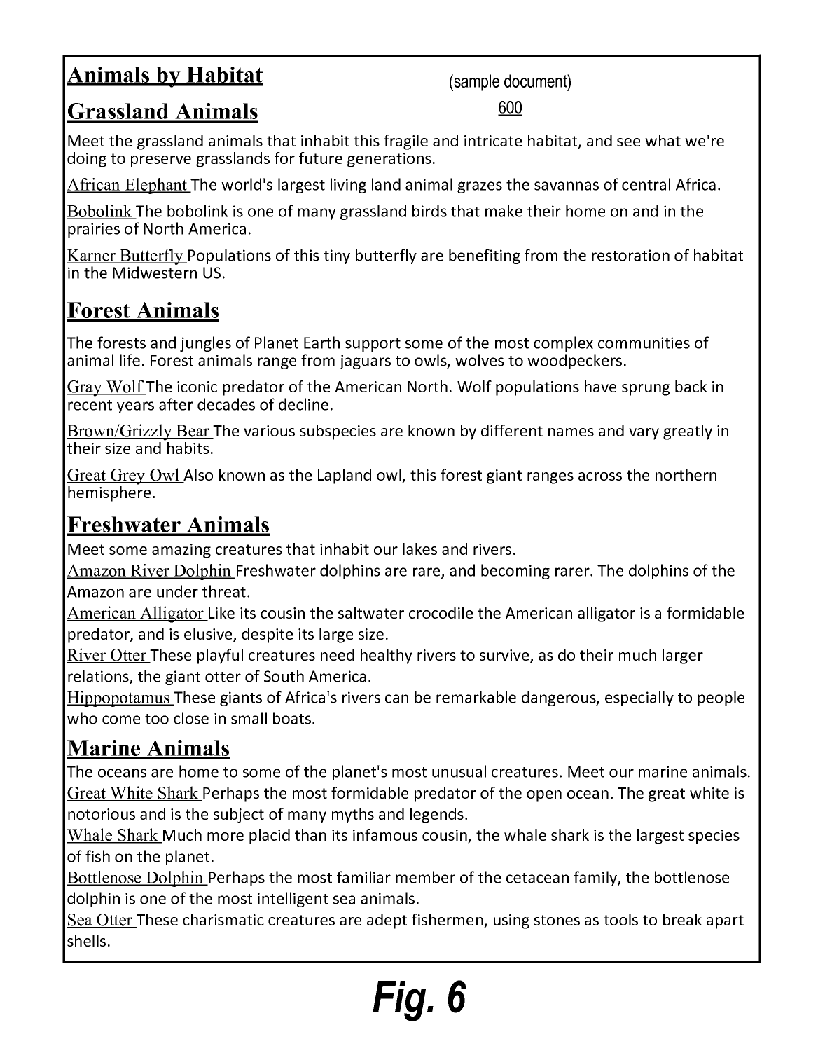

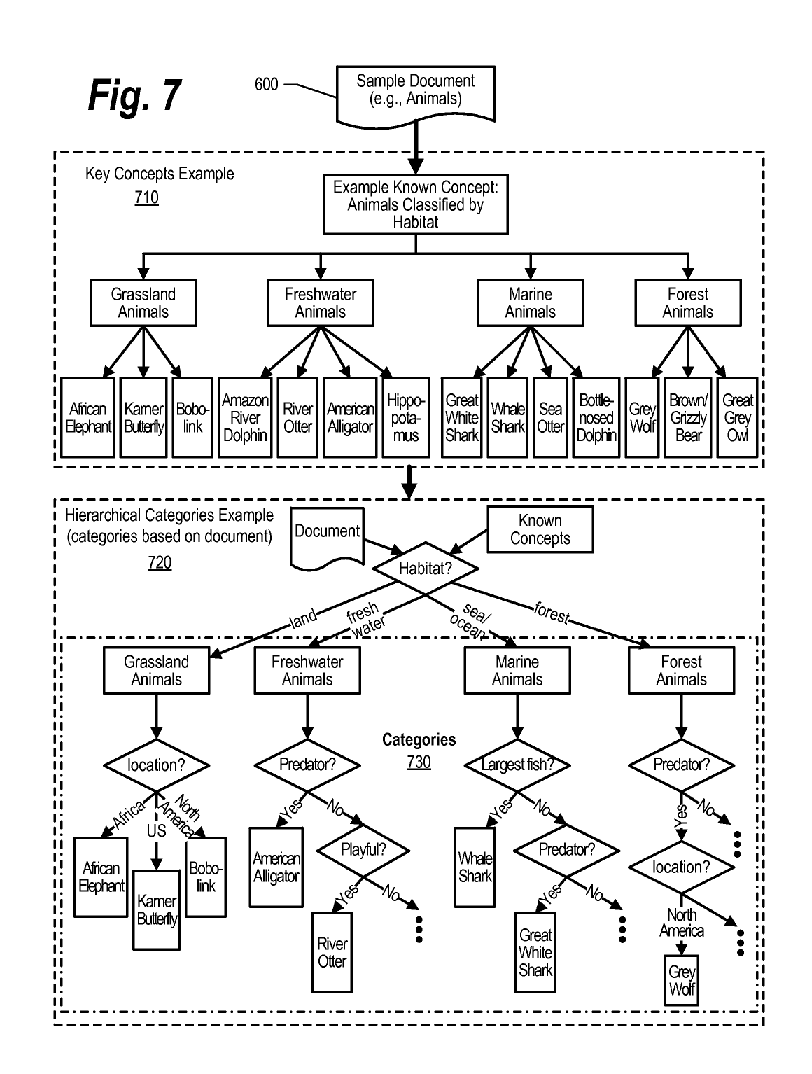

In the example shown in FIGS. 6 and 7, document 600 which is related to various animals is being ingested. Textual details of the document are shown in FIG. 6. FIG. 7 shows key concepts 710, in this case a classification of animals based on habitat. The concepts are used to break document 600. As used herein, a “concept” is a previously known categorization of a subject. In key concepts example 710 shown in FIG. 7, the various animals described in document 600 are previously known to belong to a particular concept. In the example, the concept is “habitat” which is used to divide the animals found in document 600 between “grassland animals,” “freshwater animals,” marine animals,” and “forest animals.” In one embodiment, the concepts used to process a document is based upon the content of the document. Looking at the text of document 600 in FIG. 6, the system recognizes that animals are being discussed based on habitat in light of the fact that the document title is “Animals by Habitat,” and thus the concept used to process the document is “habitat.”

The results of key concept analysis 310 are supporting passages that are extracted and stored in data store 320 as well as concepts that are annotated and broken down into a number of child level categories that are stored in data store 325. In the example shown in FIG. 7, the categories are formed from data gathered from the document. For example, within the concept of “grassland animals”, three animals are described—the African Elephant, the Bobolink, and the Karner Butterfly. The data pertaining to the three animals, ingested from document 600 detailed in FIG. 6, shows that a location for each of the animals is provided in the document. A category is established based on the location of the animal in hierarchical categories example 720 (see “location?” category with each of the three animals being categorized based upon its respective location). The child level categories are grouped based on similarities of related concepts found between child level categories. Related child level categories are grouped into sets and a parent category is created as the parent of the child level categories grouped into the same set. Based on the particular application, multiple levels of parent categories can be established with lower level parent categories grouped into a set and assigned to a higher level parent category. In the example shown in FIGS. 6 and 7, the low level (child) categories would be the various animals (African Elephant, Karner Butterfly, etc.) and the text from FIG. 6 related to each of the animals would be used as supporting passages and stored in data store 320 in FIG. 3.

As used herein, a “category” is a grouping of information obtained from a document. The lowest level “child” categories are obtained from the document. In the example, the lowest level child category is the individual animal species (e.g., African Elephant, Whale Shark, etc.). Base on the context, a category might be a “parent” category to another category or a “sub-category” (child) of the parent category. In addition, the concepts used to analyze the document can also be used as categories. In one embodiment, the concepts form the high level categories as shown by the highest level categories in hierarchy 720 shown in FIG. 7 where each of the highest level categories is one of the concepts found in key concepts analysis 710. While some categories are based on previously known information (e.g., the “habitats” found in the example shown in FIG. 7, etc.), other categories, as described in further detail below, are dynamically created based upon the information ingested in the document. For example, the category of “largest fish?” was generated by analyzing the text from FIG. 6 associated with Whale Shark that noted that the Whale Shark was the largest fish. Likewise, the categorization of some animals as being “predators” is also generated based upon the analysis of the text from FIG. 6 associated with such animals.

As previously mentioned, multiple levels of parent categories can be established as shown by the example of “marine animals,” “freshwater animals,” and “forest animals.” In “marine animals,” a category is established for “largest fish?” with the largest fish being the Whale Shark. Another category is established for “predator?” with the Great White Shark belonging to that category. The categorization of Whale Shark and Great White Shark can be seen from their respective supporting texts in document 600 shown in FIG. 6 (e.g., “Great White Shark Perhaps the most formidable predator of the open ocean. The great white is notorious and is the subject of many myths and legends.” and “Whale Shark Much more placid than its infamous cousin, the whale shark is the largest species of fish on the planet.”). Notice that the categorization of Great White Shark being a predator and the Whale Shark's categorization as being the largest fish is derived from the document text.

The child level categories and parent categories form hierarchical index 330. Using the example shown in FIGS. 6 and 7, the child level categories would be the various animals (Great White Shark, Whale Shark, African Elephant, etc.) and parent categories would be those categories shown in 730 (e.g., “location?”, “predator?”, “playful?”, “largest fish?”, etc.). The corpus is extracted from the document repository and divided into a number of sub-corpora with each of the sub-corpora being associated with one of the child level categories. For example, using the example from FIGS. 6 and 7, the text related to each animal would be extracted from document 600 and associated as sub-corpora to its respective animal (e.g., the sub-corpora for Great White Shark would be associated with the passage “Great White Shark Perhaps the most formidable predator of the open ocean. The great white is notorious and is the subject of many myths and legends.” and the sub-corpora for Whale Shark would be associated with the passage “Whale Shark Much more placid than its infamous cousin, the whale shark is the largest species of fish on the planet.”). The sub-corpora is associated with its child level category and each sub-corpora is separately indexed. In the hierarchy index, each sub-corpora is also associated with its parent categories. In the example, under the concept (parent category) of “marine animals”, the category of “largest fish?” is associated with the sub-corpora (textual passage) associated with “Whale Shark” and the category of “predator?” is associated with the sub-corpora associated with “Great White Shark.”

In one embodiment, identifying and classifying concepts is a supervised algorithm based on previously known classes. For example, take the species of animals that are divided based on their habitat as shown in FIG. 6. An animal can be living in different habitats like fresh water, land, sea, forest etc. There are certain characteristics that make an animal a particular species. A model can be developed using the data about these characteristics for which the class is already known. This model can be built into a decision tree (see category tree, or hierarchy, shown in FIG. 7), which classifies a test document such as document 600 in a straightforward manner. Test conditions are applied to the document, starting from the root node, and follow the corresponding branch based on the outcome of the test.

Runtime processing is shown with question 340 being received at step 345. The question is processed by QA System 100 for question analysis. For example, say the user poses a question for a “fresh water predator.” As the question goes through the phases of the system, the concepts are identified. In the example shown in FIGS. 6 and 7, the concept is identified is “fresh water animal”, which is at the first level in the concept tree hierarchy. The system then searches through the content under this concept with the keyword “predator”, which gives us the American alligator. In this manner, the system filters out superfluous, or unwanted, results using the dynamic expansion based on categories.

At step 350, the runtime process expands the query with the concepts hierarch that was developed during the pre-processing operations. At step 355, the process initializes the current level to the lowest child level category in hierarchal index 330. At step 360, the process retrieves supporting passages from the current level in the hierarchy which, at this point, is the lowest child level category. The process stores the results (supporting passages) in data store 365. The process determines as to whether enough supporting passages were retrieved (decision 370). In one embodiment, the process compares the number of passages retrieved to a threshold that can be set before or during runtime. If the search retrieved too few results (supporting passages), then decision 370 branches to the “no” branch whereupon, at step 375, the process moves up one level in the hierarchy (e.g., to the child's parent category that is a parent to multiple child level categories, etc.) and processing loops back to step 360 to retrieve results from this higher level in the hierarchy. This looping continues to move up further in the hierarchy until a satisfactory number of results have been retrieved, at which point decision 370 branches to the “yes” branch.

At step 378, the process performs candidate answer generation processing using the supporting passages that were retrieved and stored in data store 365. The candidate answers are stored in data store 380. At step 385, the process scores the candidate answers and the scored answers are stored in memory area 390. The process determines as to whether the scores of the candidate answers are too low (decision 392). If the scores are too low, decision 392 branches to the “yes” branch to move up another level in the hierarchy and further expand the set of categories, and related sub-corpora, that are searched for supporting passages. This looping continues to move up further in the hierarchy until the scores of the candidate answers are satisfactory, at which point decision 392 branches to the “no” branch and, at step 395, the process returns one or more of the scored candidate answers to the requestor.

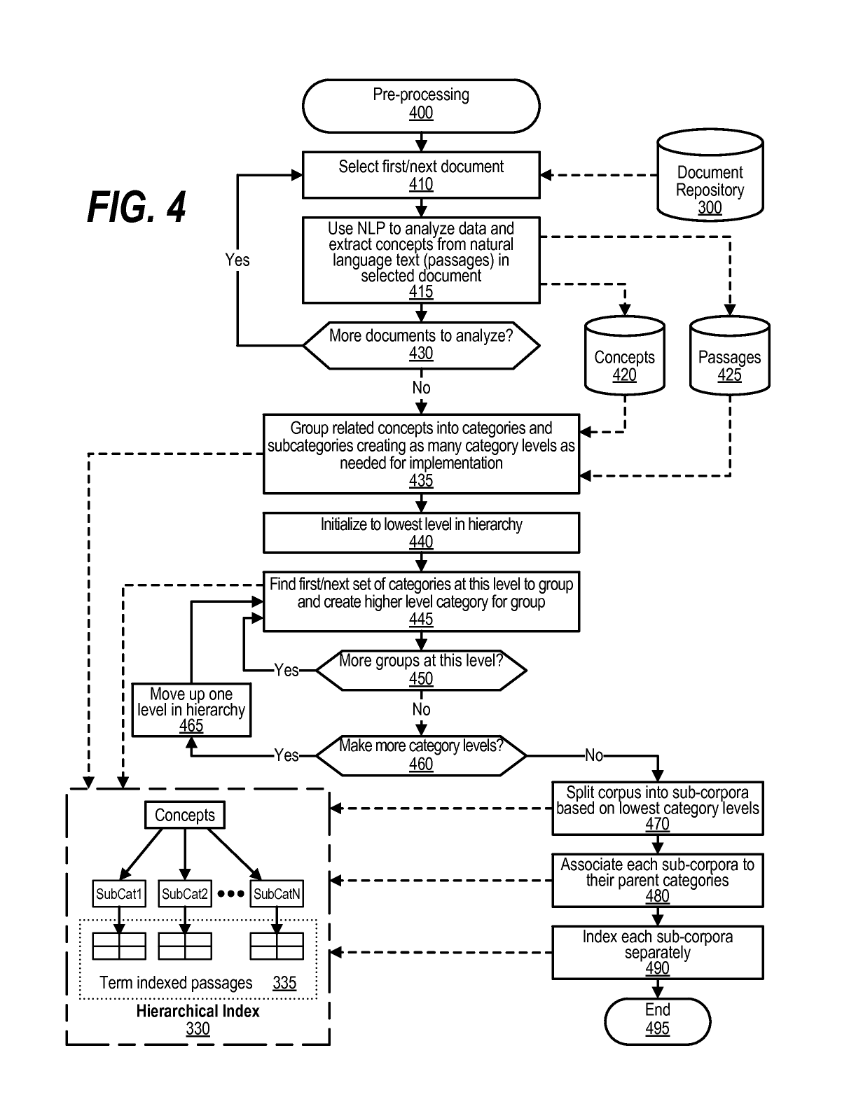

FIG. 4 is a depiction of a flowchart showing the logic used during pre-processing to provide dynamic concept based query expansion. Pre-processing commences at 400 whereupon, at step 410, the process selects the first document from document repository 300. At step 415, the process uses natural language processing (NLP) to analyze the document and extract concepts from natural language text (passages) included in the selected document. A given document may include multiple concepts and multiple passages that support such concepts. The process stores the concepts in data store 420 and the passages in data store 425. The process determines as to whether there are more documents from document repository to analyze (decision 430). If there are more documents to analyze, then decision 430 branches to the “yes” branch which loops back to select and process the next document as described above, with additional concepts and passages being added to data stores 420 and 425, respectively. This looping continues until there are no more documents to analyze, at which point decision 430 branches to the “no” branch for further processing.

At step 435, the process groups related concepts into categories and subcategories and creates as many category levels as are needed for the current implementation. Steps 440 through 490 detail the steps taken to create the categories and associate sub-corpora to both the lowest (child) level categories as well as created parent categories.

At step 440, the process initializes the current category to the lowest level category in hierarchical index 330. This lowest level category is referred to as a child level category. At step 445, the process finds a first set of categories at the current level that can be grouped based on related concepts identified among the categories included in the set. For example, the first set of categories might include four child level categories, the second set of categories might include three child level categories, and so on, with each of the sets having some related concepts. The set of grouped categories are grouped into a higher level parent category that is also stored in hierarchical index 330. The process determines as to whether there are more groups (sets) that have been identified at the current level in the hierarchical index (decision 450). If more groups have been identified, then decision 450 branches to the “yes” branch which loops back to find the next set of categories to group into a higher level parent category. This looping continues until there are no more groups identified for the current level in the hierarchical index, at which point decision 450 branches to the “no” branch.

The process determines as to whether to create additional category levels (decision 460). The number of category levels is based on the particular application and the size of the corpus that is being divided up into child level categories and associated sub-corpora. If another category level is needed (e.g., grouping parent categories into higher level parent categories, etc.), then decision 460 branches to the “yes” branch whereupon, at step 465, the process moves up one level in the hierarchy and loops back to step 445 which now finds parent categories with related concepts and groups such parent categories into higher level parent categories. This looping continues until there are no more category levels being created, at which point decision 460 branches to the “no” branch for further processing.

At step 470, the process splits the corpus into a number of sub-corpora based on the lowest (child) level categories and each sub-corpora is associated with its child level category. At step 480, the process associates each of the sub-corpora to each of their parent categories. Depending on the number of levels in the hierarchy, each sub-corpora can be associated with one to many parent categories. At step 490, the process indexes each of the sub-corpora separately. Pre-processing thereafter ends at 495.

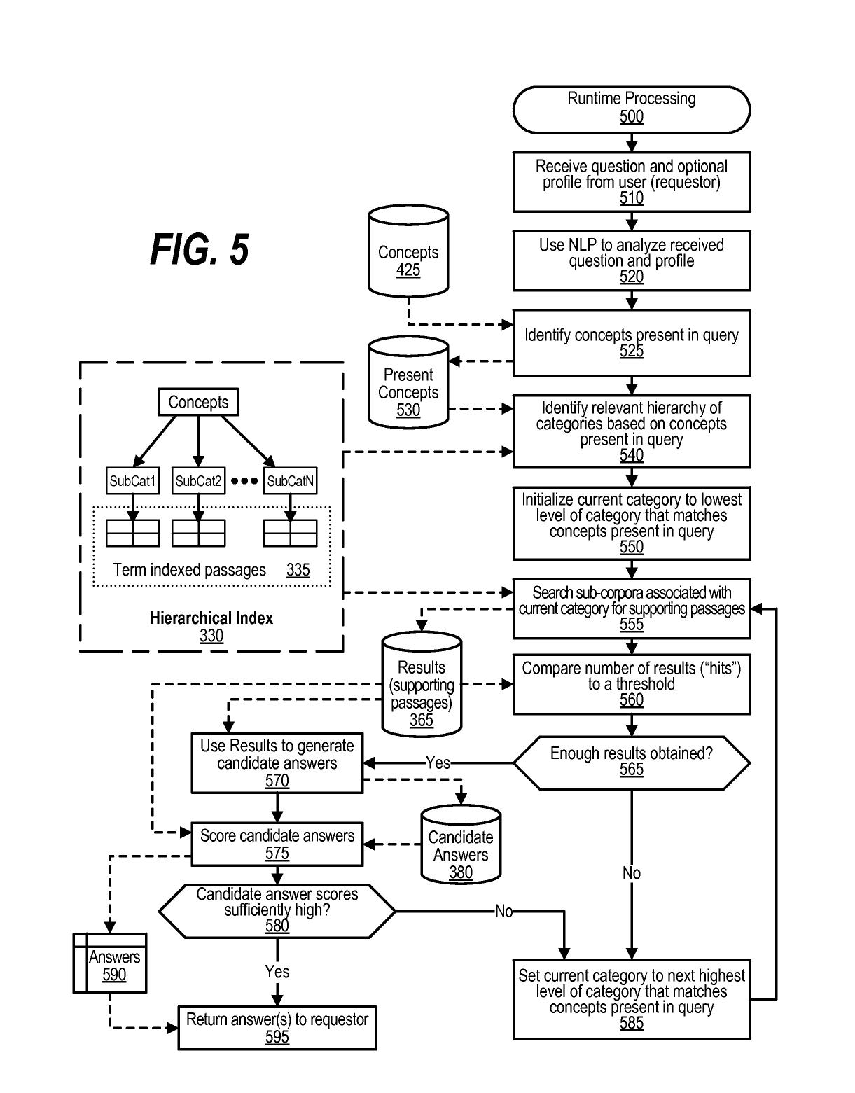

FIG. 5 is a depiction of a flowchart showing the logic used during runtime processing to provide dynamic concept based query expansion. Processing commences at step 500 whereupon, at step 510, the process receives a question and an optional profile from a requestor, such as a user of the QA System. At step 520, the process uses natural language processing (NLP) and analyzes the received question and profile. At step 525, the process uses the results of the analysis to identify one or more concepts that are present in the query. The process retrieves the list of available concepts from data store 425 and stores the concepts that are present in the query in data store 530.

At step 540, the process identifies the relevant hierarchy of categories in hierarchical index 330 with the relevant hierarchy being based on the concepts found to be present in the received query. At step 550, the process initializes the current category to the lowest (child) level category that matches the concepts present in the query. At step 555, the process searches the sub-corpora associated with the current category for supporting passages. The process stores the results (supporting passages) in data store 365. At step 560, the process compares the number of results in data store 365 to a threshold. Based on the comparison, the process determines whether the search resulted in enough supporting passages being retrieved (decision 565). If the search did not result in enough supporting passages, then decision 565 branches to the “no” branch whereupon, at step 585, the process sets the current category level to the next highest level (parent) category that matches the concepts found in the query. Processing loops back to search the sub-corpora associated with this higher level in the hierarchy with the goal of obtaining more results than previously found. This looping continues until, based on the threshold, enough results are returned, at which point decision 565 branches to the “yes” branch for further processing.

At step 570, the process uses the results (supporting passages) stored in data store 365 to generate a set of candidate answers and stores the candidate answers in data store 380. At step 575, the process scores the candidate answers and stores the scored candidate answers in memory area 590. The process determines as to whether the scores of the candidate answers are sufficiently high (decision 580). For example, a threshold might be used so that a certain number of candidate answers need to have scores that exceed the threshold value. If the scores of the candidate answers are not sufficiently high, then decision 580 branches to the “no” branch whereupon, at step 585, the process sets the current category level to the next highest level (parent) category that matches the concepts found in the query and processing loops back to step 555 to expand the search and find more results (supporting passages), and consequently, more candidate answers. This looping continues until the scores of the candidate answers are sufficiently high, at which point decision 580 branches to the “yes” branch whereupon, at step 595, the process returns one or more of the scored candidate answers to the requestor.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising a processor and a memory to expand queries processed by a question/answer (QA) system, the method comprising:
extracting, by at least one of the processors, a plurality of concepts from a plurality of documents, wherein the extracting includes utilizing natural language processing (NLP) to identify the concepts included in natural language passages found in the documents, and wherein the concepts are stored in the memory;
generating, by at least one of the processors, a plurality of child level categories in a category hierarchy from the plurality of concepts, and storing the generated child level categories in the memory;
grouping, by at least one of the processors, the child level categories into a plurality of sets based on a related concept identified for each of the child level categories included in each of the sets;
creating, by at least one of the processors, a plurality of parent categories, wherein each of the parent categories corresponds to a plurality of child level categories included in one of the plurality of sets, and storing the parent categories in the memory;
dividing a corpus utilized by the QA system into a plurality of sub-corpora, wherein each of the sub-corpora corresponds to one of the child level categories, wherein each of the sub-corpora is stored in the memory; and
answering, by at least one of the processors, a question posed to the QA system by identifying one of the child level categories related to the question and searching the sub-corpora corresponding to the identified child level category.

2. The method of claim 1 further comprising:
indexing each of the sub-corpora separately; and
associating each of the sub-corpora to the parent category of the child level category that corresponds to the sub-corpora.

3. The method of claim 1 wherein a plurality of parent category levels are created, and wherein higher level parent categories are associated with a group of related parent level categories at a lower level.

4. The method of claim 1 wherein the answering of the question further comprises:
analyzing the question by utilizing the NLP, the analysis resulting in an identification of a question concept;
identify a child level category that matches the question concept;
searching the sub-corpora associated with the identified child level category for one or more supporting passages from the natural language passages;
utilizing the supporting passages to generate one or more candidate answers;
scoring the candidate answers; and
answering the question using one or more of the scored candidate answers.

5. The method of claim 4 further comprising:
detecting a lack of supporting passages resulting from the searching;
in response to detecting the lack of supporting passages:
identifying one of the parent categories at a higher level in the hierarchy than the identified child level category; and
searching a plurality of sub-corpora associated with the identified parent category, wherein each of the plurality of sub-corpora is of child level categories previously associated with the identified parent category.

6. The method of claim 4 further comprising:
detecting that the scored candidate answers have insufficient scores;
in response to detecting the insufficient scores of the scored candidate answers:
identifying one of the parent categories at a higher level in the hierarchy than the identified child level category; and
searching a plurality of sub-corpora associated with the identified parent category, wherein each of the plurality of sub-corpora is associated with one of the child level categories included in the set of child level categories previously associated with the identified parent category.

7. The method of claim 4 further comprising:
retrieving a profile corresponding to a requestor of the question, wherein the question concept is identified based on the analysis of the question and the retrieved profile.

8. An information handling system comprising:
one or more processors;
a memory coupled to at least one of the processors;
a set of instructions stored in the memory and executed by at least one of the processors to expand queries processed by a question/answer (QA) system, wherein the set of instructions perform actions of:
extracting a plurality of concepts from a plurality of documents, wherein the extracting includes utilizing natural language processing (NLP) to identify the concepts included in natural language passages found in the documents;
generating a plurality of child level categories in a category hierarchy from the plurality of concepts;
grouping the child level categories into a plurality of sets based on a related concept identified for each of the child level categories included in each of the sets;
creating a plurality of parent categories, wherein each of the parent categories corresponds to a plurality of child level categories included in one of the plurality of sets;
dividing a corpus utilized by the QA system into a plurality of sub-corpora, wherein each of the sub-corpora corresponds to one of the child level categories; and
answering a question posed to the QA system by identifying one of the child level categories related to the question and searching the sub-corpora corresponding to the identified child level category.

9. The information handling system of claim 8 wherein the actions further comprise:
indexing each of the sub-corpora separately; and
associating each of the sub-corpora to the parent category of the child level category that corresponds to the sub-corpora.

10. The information handling system of claim 8 wherein a plurality of parent category levels are created, and wherein higher level parent categories are associated with a group of related parent level categories at a lower level.

11. The information handling system of claim 8 wherein the answering of the question further comprises:
analyzing the question by utilizing the NLP, the analysis resulting in an identification of a question concept;
identify a child level category that matches the question concept;
searching the sub-corpora associated with the identified child level category for one or more supporting passages from the natural language passages;
utilizing the supporting passages to generate one or more candidate answers;
scoring the candidate answers; and
answering the question using one or more of the scored candidate answers.

12. The information handling system of claim 11 wherein the actions further comprise:
detecting a lack of supporting passages resulting from the searching;
in response to detecting the lack of supporting passages:
identifying one of the parent categories at a higher level in the hierarchy than the identified child level category; and
searching a plurality of sub-corpora associated with the identified parent category, wherein each of the plurality of sub-corpora is associated with one of the child level categories included in the set of child level categories previously associated with the identified parent category.

13. The information handling system of claim 11 wherein the actions further comprise:
detecting that the scored candidate answers have insufficient scores;
in response to detecting the insufficient scores of the scored candidate answers:
identifying one of the parent categories at a higher level in the hierarchy than the identified child level category; and
searching a plurality of sub-corpora associated with the identified parent category, wherein each of the plurality of sub-corpora is associated with one of the child level categories included in the set of child level categories previously associated with the identified parent category.

14. The information handling system of claim 11 wherein the actions further comprise:
retrieving a profile corresponding to a requestor of the question, wherein the question concept is identified based on the analysis of the question and the retrieved profile.

15. A computer program product stored in a computer readable storage medium, comprising computer instructions that, when executed by an information handling system, causes the information handling system to expand queries processed by a question/answer (QA) system by performing actions comprising:
extracting a plurality of concepts from a plurality of documents, wherein the extracting includes utilizing natural language processing (NLP) to identify the concepts included in natural language passages found in the documents;
generating a plurality of child level categories in a category hierarchy from the plurality of concepts;
grouping the child level categories into a plurality of sets based on a related concept identified for each of the child level categories included in each of the sets;
creating a plurality of parent categories, wherein each of the parent categories corresponds to a plurality of child level categories included in one of the plurality of sets;
dividing a corpus utilized by the QA system into a plurality of sub-corpora, wherein each of the sub-corpora corresponds to one of the child level categories; and
answering a question posed to the QA system by identifying one of the child level categories related to the question and searching the sub-corpora corresponding to the identified child level category.

16. The computer program product of claim 15 wherein the actions further comprise:
indexing each of the sub-corpora separately; and
associating each of the sub-corpora to the parent category of the child level category that corresponds to the sub-corpora.

17. The computer program product of claim 15 wherein a plurality of parent category levels are created, and wherein higher level parent categories are associated with a group of related parent level categories at a lower level.

18. The computer program product of claim 15 wherein the answering of the question further comprises:
analyzing the question by utilizing the NLP, the analysis resulting in an identification of a question concept;
identify a child level category that matches the question concept;
searching the sub-corpora associated with the identified child level category for one or more supporting passages from the natural language passages;
utilizing the supporting passages to generate one or more candidate answers;
scoring the candidate answers; and
answering the question using one or more of the scored candidate answers.

19. The computer program product of claim 18 wherein the actions further comprise:
detecting a lack of supporting passages resulting from the searching;
in response to detecting the lack of supporting passages:
identifying one of the parent categories at a higher level in the hierarchy than the identified child level category; and
searching a plurality of sub-corpora associated with the identified parent category, wherein each of the plurality of sub-corpora is associated with one of the child level categories included in the set of child level categories previously associated with the identified parent category.

20. The computer program product of claim 18 wherein the actions further comprise:
detecting that the scored candidate answers have insufficient scores;
in response to detecting the insufficient scores of the scored candidate answers:
identifying one of the parent categories at a higher level in the hierarchy than the identified child level category; and
searching a plurality of sub-corpora associated with the identified parent category, wherein each of the plurality of sub-corpora is associated with one of the child level categories included in the set of child level categories previously associated with the identified parent category.
